(19) United States
(12) Patent Application Publication
(10) Pub. No.: US 2006/0288888 A1
(43) Pub. Date: Dec. 28, 2006

(54) Printing machine

(76) Inventor: Rainer Wieland, Wurzburg (DE)

Correspondence Address: CHADBOURNE & PARKE, L.L.P., 30 Rockefeller Plaza, New York, NY, 10112, US

(21) Appl. No.: 11/474,209

(22) Filed: Jun. 22, 2006

(30) Foreign Application Priority Data
Jun. 22, 2005 (DE) 10 2005 029 214.3
Jul. 7, 2005 (DE) 10 2005 032 149.6

(51) Int. Cl. B41F 17/00

(52) U.S. Cl. 101/35

(57) ABSTRACT

The invention concerns a printing machine for the imprint of individual items, notably CDs or DVDs, by means of at least one print station, utilizing one or more printing processes, whereby the individual items traverse at least one print station on a transport path in transport carriers and whereby by means of grips during one movement of the grips and the transport carriers the individual items may be delivered and picked up from the transport carriers and such individual items are centered in relation to the transport carrier during the process of delivery. The invention furthermore concerns a gripping system, transport carrier and process for utilizing the same.

### RELATED APPLICATIONS

The present invention claims all rights of priority to German Application No. 10 2005 029 214.3, filed on Jun. 22, 2005, and German Application No. 10 2005 032 149.6, filed on Jul. 7, 2005, both of which are hereby incorporated by reference.

### FIELD OF THE INVENTION

The object of the invention is a printing machine for the printing of individual items, notably CDs or DVDs, by means of at least one printing station, utilizing one or more printing processes, whereby the individual items pass through at least one printing station on one transfer run in transport carriers. The invention in addition concerns a system of grippers, a transport carrier, as well as a process for the printing of individual items.

### FIELD OF THE INVENTION

There are known printing machines for the printing of individual items with at least one flat side, as for example CDs or DVDs. Thus, German patent DE 44 38 246 describes a printing machine for the printing of CDs or DVDs by means of an offset process.

### BACKGROUND OF THE INVENTION

In the description of that patent, the items are individually carried by a system of grippers from transport spindles onto transport slides provided for this purpose, and are secured thereto by means of low pressure (vacuum). Such fixation is required for the reason that in the next following printing operation the items are exposed to mechanical stress and can be pulled down from the transport carrier by reason of adhesion of the transferred printing ink to the rubber blanket and the surface of the item.

The surfaces of the item are multi-color printed in known fashion, whereby in this instance a four-color print is first applied to a common transfer cylinder and then the complete multi-color image is transferred onto the item in a second step. The next following drying of the ink, depending on the type of ink used, fixes the image lastingly onto the surface of the item.

Inasmuch as the items are superimposed from the stock spindle by means of a gripper arm, it is necessary in the described device to stop the transport of the transport carrier in order to place the items true to size in one of the intake apertures provided on the transport carrier. A further stop sequence is required when the items are imprinted as prime coating in a next following step in a screen-printing unit.

Such screen-printing units are as a rule constructed as flat-bed screen printing machines. Conversely, the subsequent printing with offset printers calls for continuous travel of the transport carriers under the printing unit, so that the need arises from the combination of all participating motion sequences to synchronize a discontinuous with a continuous motion and to synchronize the movement of the transport carriers along the travel path between the segments of the travel. The drawback of such a combination of travel sequences lies in the fact that the implementation is associated with major mechanical and technical control outlays, causing in addition substantial expenditures.

Inasmuch as it is necessary for a centered imprint of the CD in the next following printing units for the CD to be centered on the transport carrier and fixed thereon, provision is made for a centering mandrel to pass through the center orifice immediately following the placement of the CDs onto the transport carrier. Such a centering mandrel may, for example, have a conical shape, whereby thanks to the conicity of the centering mandrel the CD is shifted into an aligned position.

Once the CD is aligned, it will be fixed in this position on the transport carrier for example with the aid of a vacuum attachment, so that the centering mandrel may again be safely removed, without changing the position of the CD. In order to prevent the centering mandrel from jamming into the central orifice of the CD—which may occur as a result of contamination or manufacturing tolerances in the production of the CDs—and in order to further enhance precise positioning, an expansion arbor may be used as an alternative to the conical centering mandrel.

Such an arbor may, for example, comprise three expansion jaws, arranged symmetrically about a common shaft, and featuring in the non-expanded state a total diameter smaller than the minimum diameters of the central aperture on the CD. By way of a common device, the jaws can be symmetrically expanded radially outward, thereby creating an effective diameter greater than, or equal to the maximum diameter of the central orifice of a CD.

For the protection of the CDs from damage, it is furthermore possible to make provision for power-limiting elements, such as springs or power sensors. Thanks to the symmetry of motion, a CD not yet centered after the superimposition is centered in relation to the centering mandrel. Inasmuch as the latter is in turn centered relative to the position of the particular transport carrier, the CD is thereby centered in relation to the transport carrier. Once centered, the CD is fixed onto the transport carrier by means, for example, of the vacuum attachment as previously described.

Once fixed, the expansion of the jaws on the arbor is reversed, so that the effective diameter of the expansion arbor is once again smaller than the minimum diameter of the central orifice on the CD. In this setting, the centering mandrel may safely be lifted out of the center orifice of the CD, without injury to the CD, or raise it again from the transport carrier in case of jamming.

### SUMMARY OF THE INVENTION

The object of the invention is to simplify the mechanical outlays and the required control expenditures for a printing machine.

This task is solved by means of a printing machine and a process whereby individual items singly or in parallel the one after another removed from a supply, as for example a transport stock or a transport spindle, are placed precisely positioned thereon in the course of continuous travel of the transport carriers, whereby the centering of the individual items on the transport carrier takes place during the delivery process. Beyond that, the uptake of the individual items from the transport carriers also takes place during the travel of the transport carriers.

Thus, according to the invention, there is no need to stop the transport carriers during the loading of the individual items in the intake of the transport carriers provided for this purpose, during the centering nor even during the removal from the transport carriers. In combination with the required travel sequences under the offset printing units, this results in a single continuous movement along the travel path of the individual items through the printing machine.

Advantageous embodiments of the invention are noted in the subsidiary claims.

Such subsidiary claims mention gripper systems and transport carriers usable in accordance with the invention to achieve centering of the items in the transport carrier and speed equalization of grippers and transport carriers.

### BRIEF DESCRIPTION OF THE DRAWINGS

Exemplified embodiments of the invention are illustrated in the following figures.

FIG. 1: Basic schematic representation of a transport device, utilized in a printing machine according to the invention;

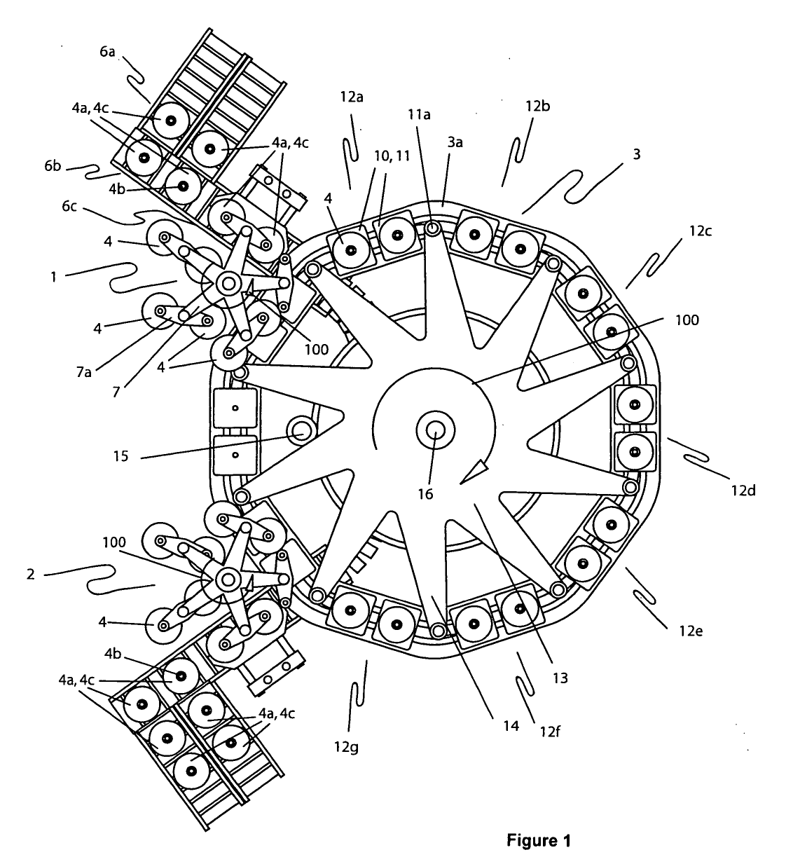

FIG. 2: A gripper device for the transport of items from a stock to the transport carrier;

FIG. 3: Detailed view of the cam-controlled mechanism of a gripper system;

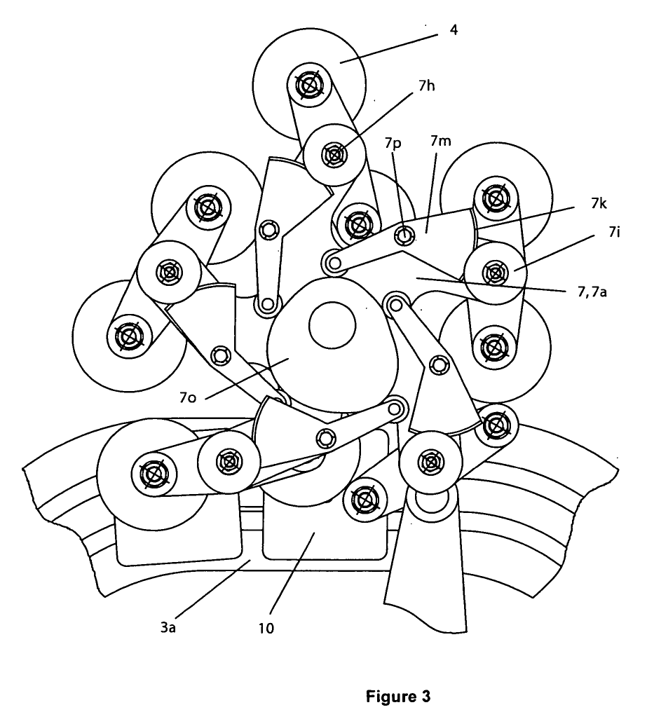

FIG. 4: The travel path of the spindles;

FIG. 5: Detailed view of a centering device on grippers and transport carriers;

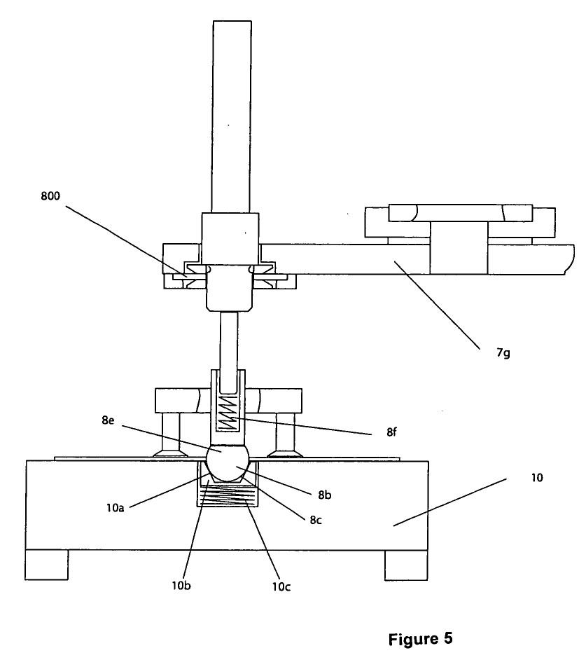

FIG. 6: A transport device with a rotary table connected ahead of or behind the gripper system;

FIG. 7: A transport device with cam-controlled drives operating the transport carriers.

### DETAILED DESCRIPTION

The complete device comprises essentially a feed system 1 designed to take up individual items 4, for example CDs, from their spindles 4a, and transport them onto the transport carriers 10 of the transport system 3, a transport system 3 with an enclosed travel path 3a, along which are arranged individual processing stations 12a to 12g for the individual items 4 located on transport carriers 10, and a pick-up system 2 designed to take up from the transport carriers 10 the individual items 4 processed along the transport system 3 and deposit them onto the spindles 4a.

The further description of the printing machine will hereunder be based on CDs utilized as the individual items, whereby other types of individual items may also be employed, without limiting the generality hereof.

Feed System

The task of the feed system 1 is to remove individually from spindles 4a, from above, the CDs 4 delivered on spindles 4a and deliver same onto the transport carriers 10. This unit must be necessarily operated in a timed sequence, inasmuch as the CDs 4 with their central orifice 401 are centrally and vertically aligned onto the axis 4b located on spindle 4a.

The pick-up can only take place from above and along the vertical axis 4b, which requires a standstill of the feed lever 7a above the spindle 4a for the time of removal of the CDs. In order to permit removal of CDs 4 from the CD stack 4c and at the same time permit a motion of the feed lever 7a over the spindle 4a, it is necessary during the standstill time for the pick-up of CDs 4 to lower the feed lever 7a or a gripping device 8 mounted thereon, so that a gripping device 8 located at the extremity of the feed lever 7a can remove a CD 4 from the CD stack 4c.

In order to afford a constant lift for this movement, the CD stack 4c on spindle 4a is lifted continuously or in small steps with the aid of a separate mechanism not illustrated here. For all practical purposes, the upper edge of the CD stack 4c is monitored by sensors not illustrated here and the effective height of the upper edge of the CD stack 4c on spindle 4a is suitably readjusted as needed, by further raising of the CD stack 4c.

In order to permit during a change of the spindle an uninterrupted feed of CDs 4 for the preservation of a continuous printing process, provision is further made to provide directly above each spindle in the take-off position in the feed system in each take-up position an intermediate storage for CDs, whose content can bridge the time gap of the spindle change, so as not to interrupt the flow of material to the printer.

The filling of such intermediate storage occurs by way of the previously mentioned lifting of the CD stack 4c in such a way that the CD stack 4c is raised high enough for the upper portion of the CD stack 4c, and by the same token a certain number of CDs 4, to lie outside the axis of the spindle 4b, projecting at the same time into the area of the intermediate storage.

In this area, the guidance of CDs 4 is no longer by way of the central orifice of CD 4 but rather by way of guidance elements arranged along the circumference of CDs 4. Beyond that, the transfer of guidance between the two areas is executed in such a way that a CD 4 is not left unguided at any point in time. By means of devices along the circumference of CD 4, the CDs 4 are held in such a way that a withdrawal of the CDs is only feasible upwards and the CDs 4 from the spindle 4a can be reloaded into the storage, but cannot fall down.

The external guidance of CDs 4 supports at the same time the placement of CDs 4 in relation to the gripping system 8.

The feed system 1 comprises, for example, a radial (star-shaped) rotary arm 7 with, for example, five feed arms 7a, which arm is rotated stepwise in a horizontal motion about an axis 7c. Each of the feed arms 7a bears at its outer end one or more grip devices 8, with in every case one or more grip elements, for example vacuum suckers 8d, aggregated in one or more groups, connected to a valve-controlled vacuum system.

Provision is additionally made for the grip device 8 to perform by way of a lifting device 7e a controlled vertical up- and down-motion, so as to remove individually during its standstill phase for example CDs 4 from the spindles 4a or to position during a standstill phase or a moving phase the CDs 4 so withdrawn onto the carriers 10, or in case of need deliver them into a code-check position not illustrated here, by which to detect the CD code by means of an optical read-out unit, or deposit them into an eject setting not illustrated here.

The lifting device 7e may be driven, for example, by means of a pneumatic cylinder or an electric drive. The timing sequence of the rotary arms is given, for example, by way of a flange-connected step-by step drive which executes, for example, a complete 360-deg. rotation per cycle. With the mentioned exemplified five pick-up arms 7a of the rotary arm 7 and the requisite symmetry of the travel sequences, this signifies one rotation of the rotary arm 7 by 72 degrees for each rotation of the cycling drive. Other combinations and values are of course also feasible, without limiting the general validity hereof.

One cycle of the step-by step drive out of the mentioned exemplified 360 degrees is further subdivided into individual travel segments with, for example, the following subdivision:

One 50-degree angle standstill, 130 deg. accelerations to operating velocity, 50 deg. constant velocity and 130 deg. deceleration down to standstill.

In this example, one complete cycle of a single pick-up arm 7a comprises five strokes, whereby during the first stroke one or more CDs—depending on the chosen number of gripping devices 8—are picked up from one or more spindles 4a. To this end, during the standstill phase of the first stroke, the gripping devices 8 of the corresponding rotary arm 7a are located directly above the spindles 4b. At this point, the gripping device 8 is moved by way of the mentioned lifting device 7e during the standstill out of the first position in the direction of the upper CDs 4 on the spindles 4a into a second position, so as to enable the gripping device 8 to pick up the topmost CD 4 from the CD stack 4c on spindle 4a.

Upon completion of the pick-up of CDs 4, the gripping device 8 is again moved back into the initial position by way of the lifting device 7e, whereby the rotary arm 7 is once again safely movable. In the next following acceleration phase of the first stroke of rotation of rotary arm 7, the constant velocity phase and the deceleration phase, the said feed arm 7a is further moved by 72 degrees with the CDs 4, arriving at a position where an optional, not illustrated optical read-out unit may be located, by which it is possible to read the mechanically legible information stored on the interior ring of each CD. In the event that this information does not match information stored in a superimposed computer system, the CD 4 will be after the next following stroke, that is, after another 72 degrees rotation, ejected at an eject station not illustrated here onto spindles 4a provided precisely for this purpose.

Where the information does match, the CD 4 stays on the gripping device 8 and is now, after the acceleration phase of the next following stroke, delivered during the constant motion phase onto the transport carrier 10, which at this point in time moves along the transport path 3a at the same velocity.

Inasmuch as the feed arm 7a executes a circular motion during this phase, provision is made, in the case that several gripping systems 8 are in use, for the same to be secured onto a rotating carrier arm 7g, mounted on a rotary axis 7h on each feed arm 7a. The carrier arm 7g may be rotated by means of a cogwheel 7i secured onto the rotary axis 7h and an index gear 7k, mounted on one end of a lever arm 7m supported revolvingly on arm 7a on an axis 7p. The other end 7n of the lever arm 7m, onto which for example a pulley may be arranged, is in operating connection with a fixed cam plate 7o.

When the rotary arm 7 is rotated with the mentioned devices positioned on the feed arm, the end 7n of the lever arm 7m glides over the edge of the cam plate 7o and controls the position of arm 7g by way of the index gear 7k and the cogwheel 7i. By way of an appropriately shaped cam plate 7o it is thus possible during the travel phase of the delivery or pick-up of CDs 4 upon or from the carriers 10 to equalize the circular motion of the rotary arm 7, and the carrier arm 7g located at its end, to the pattern of movement of carriers 10, to permit delivery and/or pick-up of CDs 4 upon or from the carriers 10.

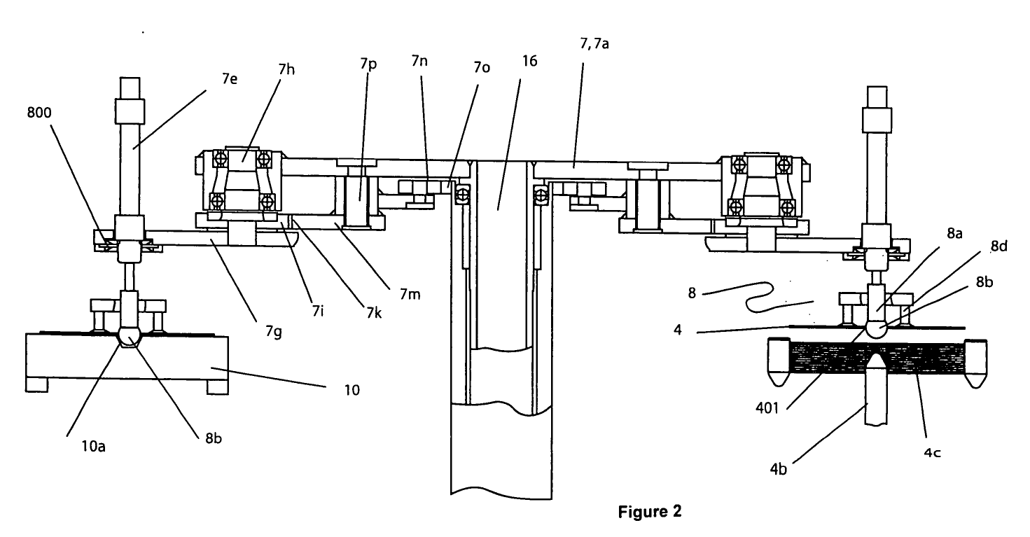

Inasmuch as it is necessary for a centered imprint of the CDs 4 in the printing stations 12a to 12g following in sequence along the transport path 3a for the CDs 4 to be placed centered on the transport carriers 10 and secured in this position, provision has been made on each gripping device 8 as shown in FIG. 2 for a centering device 8a which operates during the uptake of a CD 4 from the CD stack 4c to center the CD in relation to the gripping system 8, and additionally during the delivery movement of the CD 4 onto the transport carrier 10 to deposit the CD 4 centered on the transport carrier 10, where the same is secured immediately thereafter, for example by vacuum.

To this end, the extremity of the centering device 8a is constructed as a convex cup 8b, against which the CD 4 is pressed after lifting off from CD stack 4c onto the spindle 4a so that the cup 8b engages the center orifice 401 of the CD 4. If the gripping device 8 is outfitted with flexible suction vacuums 8d, this can be achieved by applying the vacuum to the suction units and the resulting contraction of the vacuum suction unit. In this manner, the vacuum on the one hand holds the CD fixed and on the other, presses it with its center orifice 401 against the said cup 8b, thereby centering the CD 4 in relation to the gripping system 8.

Alternatively, the gripping system 8 may be flexibly suspended and/or the center orifice 401 of the CD 4 may be pressed against the cup 8b with a separate controlled-motion element. The effective diameter of the cup 8b is chosen greater than the maximum diameter of the center orifice 401 of the CD 4, thereby preventing the CD center orifice from jamming.

In order to ensure a precisely positioned transfer of the CD 4 on the transport carrier 10, provision is further made for the transport carrier 10 to be outfitted with a centered concave opening 10a, which is engaged by the cup 8b during the delivery of the CD, thereby centering the picked up CD 4 in the desired position on the transport carrier 10. As an alternative to the mentioned spherical cup 8b, other shapes may be chosen to fulfill the same purpose.

In particular, the radius of curvature of the mentioned cup 8b and of the mentioned concave opening 10a may be identical or may feature a different radius and diameter. Inasmuch as the items to be imprinted may possess different thicknesses, as for example the CDs with a nominal thickness of 1.2 mm or DVD halves with a thickness of 0.6 mm, a given combination of cup 8b and concave opening 10a would only work with the required precision for one particular thickness of the item to be imprinted, namely, if the item were too thick, the cup 8b would not reach the bottom of the concave opening 10a, and if the item were too thin, it would fall uncontrolled onto the surface of the transport carrier 10 upon shutting off the vacuum from the vacuum suction 8d. In either case, a precisely positioned delivery would not be feasible.

In order to ensure precisely positioned delivery independent of the thickness of the item, provision has further been made for the concave opening 10a to be provided on the surface of a punch 10b, mounted tight and over a compression spring 10c in the transport carrier 10. In such a case, the cup 8b should then be shaped in such a way that for all anticipated different item thicknesses, the anterior rim 8c of the cup 8b after the uptake of an item lies so far below the lower edge of the item that the anterior rim 8c engages the concave opening 10a and presses it downward, depending on the thickness of the item to be imprinted.

As an alternative hereto, a contact piece 8e, for example a sphere mounted on a compression spring 8f, may be arranged on the anterior rim 8c of the cup, centered in relation to the axis of the cup. In a manner similar to the placement of the item on the transport carrier 10, this acts in such a way that, on the one hand, it engages concentrically the concave opening 10a, thereby centering the cup 8b together with the item placed thereon in relation to the delivery position on the transport carrier 10, and on the other hand, equalizes with its spring-loaded setting the differential thicknesses of the items, whereby the contact piece 8e features a diameter smaller than the smallest diameter of the center openings of the particular items.

A main task of the invention is to permit placement of the CDs 4 onto the transport carriers 10 during the uniform movement of the otherwise cyclic operation of the feed system 1. As already shown in the above example, this may take place within the said 50-degree angle of one stroke of the step-by-step operation during which the feed arms 7a motion is uniform. In the cited example, these 50 degrees correspond to a 10-degree angle on the feed arm 7a.

Inasmuch as the motion of the feed arms 7a is circular about the axis of rotation of the rotary arm and the motion of the transport carrier on its transport path, as described further on, can be circular about the axis of rotation of the radial drive or even linear, a deviation occurs in the superimposition of uniformly moved path segments between the stretches of travel at right angles to the common direction of travel.

Depending on the radius in use, this deviation may range between ±0.01 mm and ±1 mm. To compensate for this deviation, which may continuously change during the motion, the gripping device 8 is additionally secured to the centering device 8a on the feed arm 7a by way of a flexible support 800. This ensures that in placing the CDs 4 onto the transport carrier 10, the cup 8b of the centering device 8a slips into a concave opening 10a provided for this purpose on the transport carrier 10, and the CD 4 previously centered on the cup 8b now also lies centered on the transport carrier 10.

In this position, for example, a vacuum system integrated in the transport carrier 10 is activated, securing a CD 4 lying thereon by the vacuum so produced, by way of ducts and openings not illustrated here, as for example perforations in the CD-bearing areas on the surface of the transport carrier 10. For practical purposes, the arrangement of the openings or perforations in the bearing surface is such, that a superimposed CD covers completely all the openings.

In an alternative embodiment, the individual openings and their feed units may be consolidated in groups and controlled separately by way of individual valves. This has the added advantage that, depending on the geometric arrangement of the said openings, it is possible to secure onto the transport carriers 10, CDs of different size or different shape, or other items to be imprinted, by switching on merely the groups corresponding to a particular shape.

Transport System

The transport carriers 10 themselves are guided along an essentially polygonal closed transport path 3a. Within the meaning of the invention, the term polygonal transport path is understood to mean that several linear transport path segments are adjoining each other, whereby adjoining linear transport path segments stand at an angle to each other, whereby in particular all linear transport path segments are of the same length and adjoining segments always possess the same angle to each other, thereby creating a rotationally symmetric transport path around a particular center. Preferentially the individual linear transport path segments always convert into each other, that is to say, contrary to the mathematical polynomial, the linear segments convert rounded out into each other.

The number of linear transport path segments preferentially matches the number of the utilized transport carriers 10, loaded with CDs for each stroke of the feed system 1. Thus, for example, if the feed system 1 always removes only one CD 4 from a CD stack 4c of a feed spindle 4a and delivers it to a transport carrier 10, then the number of linear transport path segments matches exactly the number of transport carriers in use.

For example, with the number of linear transport path segments at ten, the number of transport carriers 10 in use is likewise ten. Alternatively, for example, if the feed system takes up in each case two CDs from two different CD stacks 4c of two feed spindles 4a and deposits them on two different transport carriers 10, then the number of linear transport path segments will match exactly one half of the transport carriers in use. Thus, with a number of, for example, ten linear transport path segments, there will be twenty transport carriers 10 in use. Depending on the number of simultaneously deposited CDs 4, adjoining transport carriers 10 will be consolidated into groups 11, whereby the individual transport carriers are connected to each other by way of a hinge 11a. In the process, the length of the linear transport path segments within the feed range will be at least as long as the sum of the total length L of such a group 11 connected by way of the hinges 11a and the stretch s covered at the predetermined velocity v during the process of placement of the CDs 4 upon the transport carriers 10. Where a group 11 is located within the linear transport path segment, the distance of the concave openings 10a on the delivery surfaces of the transport elements 10 consolidated within a group 11 will in addition match the distance of the cups 8b on a feed arm 7a of the feed system 1.

The guidance of the transport carriers 10 takes place, for example, in guidance tracks along the mentioned polygon stretch 3a, whereby by the use, for example, of V-shaped grooves and correspondingly shaped pulleys, the travel in a direction radial to the rotation axis 16 of the radial drive 13 is executed free of play.

The drive of the transport carriers 10, and/or the groups 11, takes place by way of a radial drive 13 mounted revolvingly in the center of the polygon transport path which, consistent with the number of transport carries 10 and/or transport carrier groups 11, features at all times the same number of drive arms 14, which are linked at their ends, over a rotation axis with the hinges 11a, always with one transport carrier group 11.

What is advantageous here is that the requisite vacuum supply for each transport carrier 10 can be supplied over one common central vacuum connection on the axis 16 of the radial drive 13, thereby avoiding costly and unreliable vacuum slide bars. To this end, the radial drive 13 is constructed hollow and is outfitted with a rotational vacuum connection. In addition, it is possible to mount along the pertinent drive arms 14 of the radial drive 13 or upon a common assembly plate the requisite control valves for the vacuum and/or electrical control attachments, connected to the superimposed control and power supply by way of the sliding contacts mounted on axis 16.

The radial drive 13 is driven over a central drive motor 15, operating for example by way of free-from-play toothed gears, or drives a central gear mounted upon a rotational axis 16 of the radial drive 13. The velocity of the travel of transport carriers 10 is essentially constant, at least during the printing process, and is thus synchronized with the velocity of the feed system 1 and the velocity of the pick-up system 2 during their constant-speed travel stretches, so as to ensure synchronized travel of the feed system 1, pick-up system 2 and transport carriers 10 during these stretches of time. For purposes of travel synchronization, the drive motors of the feed system 1 and the pick-up system 2 are synchronized by way of an appropriate electronic control with the drive of the radial drive 13.

The pertinent processing stations, as for example printing units, are arranged along the corresponding linear transport path segments in the linear stretches 12a to 12g. Depending on the desired imprint, these may be printer units of all conventional printing processes, such as for example rotary screen printing, flexo printing, offset printing or even inkjet printing, or a combination of different printing processes, whereby the printing velocity of the appropriate printing units matches the velocity of the transport carriers 10 traveling along the segments 12a to 12g under the printing units.

This makes it possible to ensure a registered imprint along the peripheral register. For the synchronization of the travel, the pertinent printing units in segments 12a to 12g may, for example, feature individual drive motors, such as synchronous motors, which can be synchronized with the drive of the radial drive 13 by way of a suitable electronic control. Alternatively, to ensure precise synchronization at every point in time, a mechanical coupling may be arranged of the printing units with the central drive of the radial drive.

Additional processing stations, as for example cleaning fixtures and attachments for hardening or drying of printing inks, may also be arranged within the linear region of the polygon sectors, or where appropriate even in the non-linear sectors, that is to say, the curved transitions between two linear transport path segments, provided there is no need for hairline precision or precise travel of the transport carriers in relation to the processing stations.

In particular, a print-check system can be mounted alongside the last linear stretch 12g of the transport path 3a to monitor automatically the printing quality, whereby the images printed on each individual CD 4 can be rated GOOD or POOR. The advantage of such imaging systems and procedures lies in the fact that, independent of the operator, it is possible to secure a binding and reliable appraisal of the quality of print achieved.

Depending on a multitude of predetermined quality parameters, the print quality of each individual CD is assessed and stored as GOOD or POOR in the internal memory of a connected computer system. In addition, the sequential location of the CD is noted for further processing. This information may be evaluated by way of an integrated computer system in order to control the placement of the CDs in the next following pick-up system 2, either in the delivery spindles for CDs rated GOOD, or in the reject spindles for CDs rated POOR.

Pick-Up System

The pick-up of imprinted CDs 4 from the transport carriers 10 takes place in the pick-up system 2, next following the position of the last processing station 12g. In principle, the function of the pick-up system 2 is identical to the function of the feed system 1, but in reverse order of processing stages.

The imprinted CDs 4 are picked up from the transport carriers 10 by means of a gripping device 80. Just as in the case of the feed system 1, this takes place during the travel of the transport carriers 10, so that the rotary arm 70 with the pick-up arms 70a located thereon must execute the same motion sequences and fulfill the same conditions as in the feed system 1. During the pick-up stage of CDs 4 from the transport carriers 10, one pick-up arm 70a together with the gripping device 80 mounted at its extremity is located above the transport carrier 10 with the CD 4 located upon it.

By dropping the gripping device 80 from its initial setting, with the aid of a lifting device 70e identical in type and kind to the one in feed system 1, into a second setting, the gripping device 80 comes into mechanical contact with the CD 4 and grabs the CD 4 for example by applying vacuum to the available vacuum suction units. At the same time, or briefly before this point, the vacuum holding the CD 4 securely on the transport carrier 10 is shut off, so that the CD 4 can be easily removed. Once the CD 4 is gripped by the gripping device 80, the latter is moved back by way of the lifting device 70e into its original position and upon conclusion of this cycle of travel, it stops outside the travel track 3a in its original setting.

At this or a next-following stop position of the cycled movement of rotary arm 70 of the pick-up station 2, there can be located a drop-off station for CDs 4 rated POOR in an earlier assessment of the printing outcome at the aforesaid position 12g. Inasmuch as the location of the individual CDs 4 on their way from the print-check system can readily be traced by a computer system, it is possible in a simple manner to discard the CDs rated POOR separately in this reject position. For the placement of CDs 4 onto the spindles 4a it may be opportune to drop the pick-up arm 70a with the aid of the lifting device 70e out of its initial topmost position at least so far down into a second position as to enable safe deposition of the CDs 4 onto the spindle 4a.

In the event that the imprinted CD 4 was rated GOOD, the CD 4 stays on the gripping device 80, to be deposited in a next following cycle in a further setting on the delivery spindle provided for this purpose. Here, too, it may be practicable for the pick-up arm 70a to be lowered with the aid of the lifting device 70e from its initial topmost position at least so far down into a second position, as to enable a safe deposition of the CDs 4 onto the spindle 4a.

In contrast to the feed system, precise positioning need not be observed here, so that it is possible to dispense with the centering device provided for in the feed system.

For the sake of a closer illustration, the path of a CD through the machine is described hereunder:

In an initial step, an operator places a spindle onto the described conveyor belt which transports the spindle into the pick-up position. In this setting, the CD stack is raised as described high enough for the topmost CD to be readily reached by the gripping device of the feed arm. At this point, the topmost CD is now picked up as previously described from the CD stack in the feed system by means of a gripping arm and is transported into a next following position, at which the I.D. number of the CD is checked. Upon successful examination, the CD is deposited in a next following step onto a transport carrier.

During such deposition, the transport carrier moves at a preferably constant track speed along the described polygonal path. Along the linear stretch of the path, there are arranged individual printing stations. Now, in an initial printing station, white ink is applied in order to produce a white background for the image to be printed, preferably in a screen printing process, so as to secure a high degree of coating. In the event that the printing process employs radiation-hardened printing inks, a hardening attachment, for example a UV drier, is mounted preferably directly after the printing station.

In the next following printing stations, operating for example by an offset printing process, the half-tone images are now imprinted over the previously applied white background. In order to avoid dragging the ink from one printing unit to the next, it is advisable here, too, to provide a drying attachment after each printing unit. These may also be UV driers if radiation-hardening printing inks are in use.

The number of image-producing printing units depends on the number of desired color separations and matches 4 printing units in conventional CMYK printing units. Following the imprint of the CD with the white background and the color image, a further printing station may be added by which to imprint further information whose color or varnish cannot be handled by the preceding printing units, or whose printing inks or varnishes cannot be processed in the described offset printing units. Such a printing station may, for example, be constructed as a screen printing unit, in order to apply a protective varnish onto the printed image. Such a varnish must, on the one hand, be applied relatively thick, to produce the desired protective action, but must on the other hand also be relatively low-viscosity in order to provide a compact, glossy surface. Such varnishes are difficult, if not at all impossible to process in offset printing units.

Alternatively, it is also possible to apply variable data by means of inkjet printing, for example to create consecutive numbering of the products. After passing through the last printing unit and, if needed, a subsequent drier, a print-check system may be mounted on a further station along another linear stretch of the polygonal transport path, thereby to assess the print quality of the printed image on each individual CD and compare it to a reference image.

In a next following unit, the printed CD is picked up from the corresponding transport carrier by means of a pick-up system and, depending on the outcome of the previous assessment, it is delivered to a heretofore empty CD spindle provided for this purpose. The pick-up of the CD from the transport carrier takes place during the continuous motion of the transport carrier by means of a gripping system similar to or identical with the one on the feed system. The delivery of the CDs onto the mentioned reject spindle occurs only when the aforesaid assessment of the printed image has rated such CDs as POOR; otherwise, when the outcome is GOOD, the CD will be carried further in a next following stroke to the actual delivery spindle and deposited thereon.

Spindle Transport

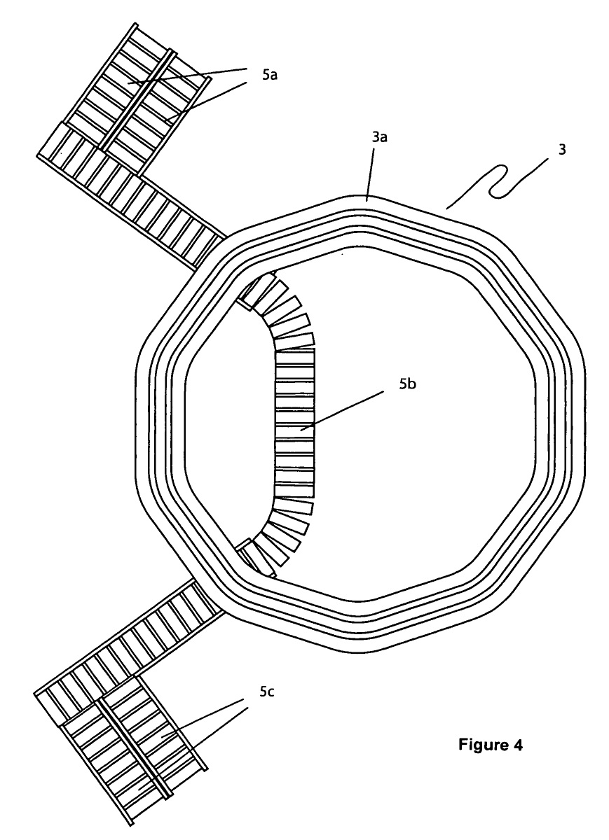

Provision is further made for the spindles utilized in the machine to be automatically transported from the intake end of the feed system to the delivery end of the pick-up system in such a way that the spindles filled with as yet unprinted CDs are emptied in the feed system, transported further to the pick-up system and there filled once again with imprinted CDs. FIG. 4 illustrates the transport path of the spindles.

To this end, the spindles 4a filled with unprinted CDs are placed by an operator onto a continuously moving conveyor belt 5a, from which they are forwarded by means of the conveyor belt 5a to a stop position. A pneumatically controlled cylinder not illustrated here projects in an initial position into the path of the spindles 4a and stops the spindles 4a initially in a stand-by position. If the conveyor belt 5a is constructed as a chain-link belt with sliding plastic components, there is no need to stop the conveyor belt 5a too. In such a case, the components of the conveyor belt 5a slide beneath the spindles 4a without tilting them over or exerting undue friction. For an initial loading of spindles 4a onto the feed system, depending on its structure, one or more spindles 4a are conveyed to their appropriate operating position 6c. To accomplish this, the said pneumatic cylinder is switched from its initial position to a second position in which it does not interfere with the transport path of the spindles 4a. Having allowed through the requisite number of spindles 4a, the pneumatic cylinder travels back to its initial position 6a and blocks further spindles.

The spindles 4a allowed through are next conveyed to a second arrest position 6b by means of the conveyor belt 5a, from which with the aid of a second pneumatic cylinder not illustrated here they are shifted for example at right angles to the travel direction of the conveyor belt into the actual operating position 6c. In this position, the spindles 4a are secured by means of a clamping device not illustrated here, and at the same time aligned in their position versus the pick-up arm 7, thus permitting unobstructed pick-up of CDs 4 by means of the pick-up arm 7. This operating position 6c is located beneath a standstill position of the pick-up arm 7. As soon as the spindles 4a reach this position, the CD stack 4c is raised by means of a lifting device into a temporary storage and to the operating position for the pick-up, so that the described pick-up system is able to pick up the CDs 4 individually from the CD stack 4c. At the same time, it is now possible to convey the next number of spindles 4a into the second arrest position, in order for the operating spindles to be replaced with loaded spindles as soon as possible after emptying.

Once a spindle 4a is emptied, the lifting device is first off returned to its original position and the fixation of the spindle is released and the now-empty spindle 4a is removed from its operating position by means of a transport device. For all practical purposes, this is accomplished in a direction opposite the stand-by position of the next following spindles. In order to afford as automated a production sequence as possible, provision is made for the emptied spindles 4a to be conveyed with a transport device 5b for example under the transport system 3 to the pick-up system 2, from which they are conveyed depending on destination to a reject position or a delivery position.

The control of the flow of spindles is comparable to the feed system 1. According to need, the empty spindles 4a are first of all held in an initial standby position by means of one or more pneumatically controlled arresting cylinders, to be then conveyed into one of the two fill positions—the operating position or the reject spindle position not illustrated here. Once a spindle is filled, it is shifted by analogy to the feed system out of its operating position by means of a transport system onto a delivery belt 5c, from which it can be removed by the operator. The same is true of filled reject spindles, whereby a separate conveyor belt is utilized for practical purposes, to rule out any possible confusion between reject spindles and delivery spindles.

Other Embodiments

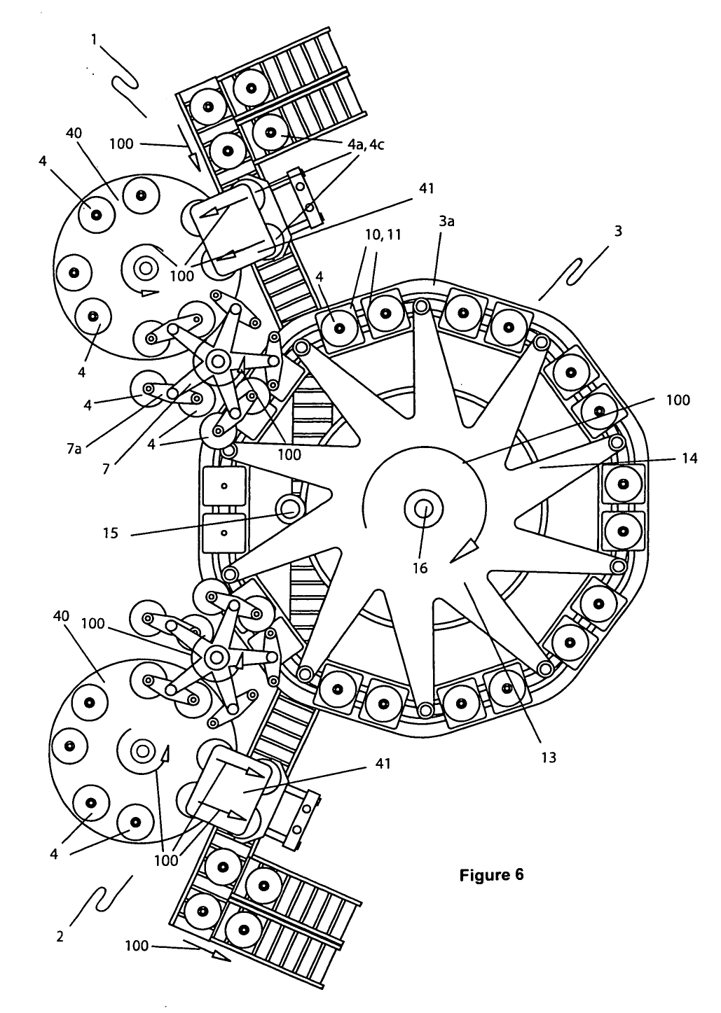

In a further embodiment according to FIG. 6, provision is made in the feed system 1 and the pick-up system 2 for an additional integrated rotational table and/or rotary indexing table 40. In such a case, CDs 4 are conveyed from the CD spindles 4a of the feed system, by means of simple pulsed-action parallel lifts 41 onto deposit surfaces provided on the rotary indexing table 40, and are secured thereto, for example, by vacuum. Inasmuch as the rotary indexing table is operated in cycles, it is possible to mount in a deposit position next following in the rotational direction of the cycle for example a flat screen print unit, as customarily used in the imprinting of the whitening coating.

It is likewise possible to mount in the pick-up system 2 in a similar position a flat screen print unit for varnishing imprinted CDs, or to mount in another position the aforesaid print-check system. In the case of radiation-hardened printing inks, a drying system is integrated after the printing unit or the varnishing unit. The previously described feed system picks up in a next following position the white-printed CDs 4 from the rotary indexing table 40 and deposits them in the described manner onto the transport carriers 10.

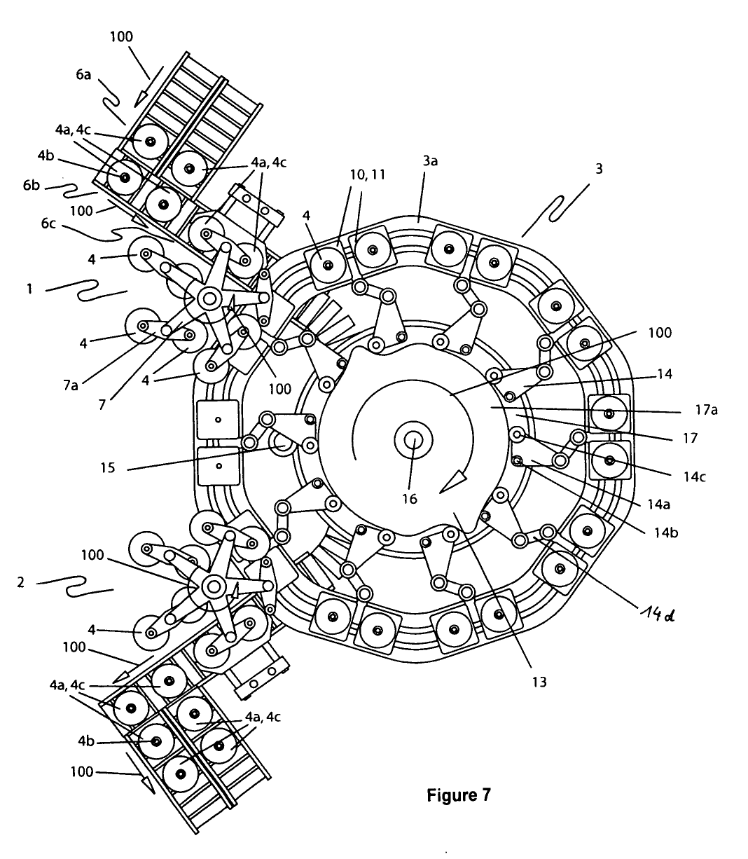

In a further embodiment schematically represented in FIG. 7, provision is made for the motion control of each individual carrier 10 in certain locations along the transport path 3. To this end, the common drive motor 15 of the radial drive 13 rotates as heretofore at a constant number of revolutions, whereby the energy is transferred as described by way of the cogwheels on the radial drive 13. For the control of the track velocity of individual carriers 10 in specific positions of the polygonal path, provision is made for the corresponding drive arms 14 to be constructed as hinged arms.

The first segment of the hinged arm 14a is linked to a common turntable 17 by way of an axis of rotation 14b. A runner 14c mounted on the hinged arm 14a spaced away from the axis of rotation 14b is pressed by way of a turnbuckle not illustrated here against a stationary cam plate 17a. If now the turntable 17 is moved with the hinged arms 14a mounted thereon, the runners 14c slide along the edge of the stationary cam plate 17a.

Depending on the shape of the cam plate, the hinged arm 14a is thus rotated more or less out of its center position. A transmission arm 14d, mounted revolvingly on its opposite end, linked to the corresponding carrier 10 by way of a rotary axis, transmits the power of the drive motor 15 onto the carrier. At the same time, carrier 10, depending on its position along the transport path, is accelerated or decelerated by the shape of the cam plate.

This makes it possible, at a constant speed of the drive motor 15, to bring the transport carriers at given positions of the transport path to a brief standstill, so that for example during such a standstill a CD lying on the transport carrier 10 may be imprinted on a flat screen printing unit.

It is similarly possible to equalize the speed variations of the carriers along the linear stretches of the polygon path thanks to the shape of the cam plate in such a way that the carriers feature constant speed during the travel under the printing units.

In this way, it is possible to avoid costly electronic synchronization measures between the effective track velocity of the carriers and the revolving speed of the rotary printing units.

Markings
1 Feed system
2 Pick-up system
3 Transport system
3a Transport path
4 CD
4a CD spindle
4b Spindle axis
4c CD stack
5a, 5c Conveyor belt
5b Transport device
6a Initial stop position
6b Second stop position
6c Operating position
7 Rotary arm
7a Feed arm
7c Axis
7e Lifting device
7g Arm
7h Axis of rotation
7i Cogwheel
7k Partial cogwheel
7m Lever arm
7n Lever arm extremity
7o Cam plate
8 Gripping device
8a Centering device
8b Cup
8c Anterior edge of cup
8d Suction vacuum
8e Pressure plate
8f Compression spring
100 Direction of transport or rotation
10 Transport carrier
10a Concave orifice
10b Punch
11 Transport carrier group
11a Hinge
12a to g Position of printing stations
13 Radial drive
14 Drive arm
15 Drive for radial drive
16 Axis
17 Bearing
19a, 19b Stop and fixation arrangement
20 Deposit position
30 Pick-up position
70 Rotating arm
70a Pick-up arm
70e Lifting device
80 Gripping device
401 Centering orifice of CD

1-23. (canceled)

24. A printing machine for the imprint of individual items comprising:
at least one printing station utilizing one or more printing processes, whereby the individual items traverse the at least one printing station on a transport path in transport carriers, one or more grips interacting with the transport carriers such that during one movement of the grips and the transport carriers, the individual items can be delivered onto transport carriers and picked up from transport carriers and that such individual items may be centered in respect to the transport carriers during the process of placement.

25. The printing machine of claim 24 wherein the individual items are disk media such as CDs or DVDs.

26. The printing machine according to claim 24 wherein during the placement and the pick-up, the velocity of a grip is equalized to the velocity of a transport carrier.

27. The printing machine claim 24 wherein the printing machine features one single common drive for the movement of all transport carriers along an enclosed transport path.

28. The printing machine according to claim 24 wherein an enclosed transport path of the transport carriers constitutes a polygon of several linear transport path segments of equal length, steadily shifting over into each other.

29. The printing machine according to claim 28 wherein the number of transport carriers equals the number of linear transport path segments.

30. The printing machine according to claim 28 wherein the number of transport carriers is an integer multiple of the number of linear transport path segments.

31. The printing machine according to claim 27 wherein the common drive comprises a star-shaped wheel, arranged in the center and symmetrical to the transport path, whereby one or more cams pointing outwards are mounted radially on the star-shaped wheel, such that the radially arranged arms of the wheel drive the transport carriers.

32. The printing machine according to claim 24 further comprising a cam that is connected to a transport carrier in such a way as to compensate for a changed spacing between the transport carrier and the cam by fixation of a bearing featuring an eccentricity or a slotted connection.

33. The printing machine according to claim 27 wherein the drive is regulated in such a way that a transport carrier travels at a constant speed within at least one portion of a linear transport path.

34. The printing machine according to claim 24 further comprising a cam that is constructed as a first hinged arm which is secured on one end onto a wheel revolving about an axis; wherein the first hinged arm features at its other end a second hinged arm, acting as drive on a transport carrier and is secured to the transport carrier.

35. The printing machine according to claim 24 wherein a first hinged arm is linked on a wheel-sided end, spaced away from a hinged securing spot, in order to effect, during the rotation of the wheel, a rotation of the initial hinged arm predetermined by the cam plate, about the wheel-sided attachment.

36. The printing machine according to claim 35 wherein consistent with the shape of the cam plate, at constant rotation of the wheel, the velocity of the transport carriers can be accelerated, decelerated or stopped.

37. The printing machine according to claim 24 wherein the number of transport carriers equals the number of arms of wheel.

38. The printing machine according to claim 24 wherein the individual items are withdrawn in cycles from a feed storage using at least one grip.

39. The printing machine according to claim 24 wherein the individual items are secured onto the transport carriers by means of a vacuum such that a vacuum supply of each transport carrier is rigidly connected to a central vacuum supply.

40. The printing machine according to claim 39 wherein control valves controlling the vacuum are secured to the drive wheel and electric control is performed by revolving sliding contacts mounted on the axis of the drive wheel.

41. The printing machine according to claim 24 wherein a vacuum supply for the transport carriers is provided by a central vacuum supply mounted in the axis of the drive wheel.

42. A gripping system comprising at least one grip for depositing and centering individual items to be imprinted a transport carrier; wherein the grip comprises a centering arrangement with a centering extremity which projects into a center opening of an item such that the item can be centered and aligned with respect to the deposit surface of the transport carrier.

43. The gripping system of claim 42 wherein the centering extremity is cup shaped.

44. The gripping system according to claim 42 wherein the centering extremity is designed to mesh during the placement of an item on the transport carrier into a recess on the surface of the transport carrier, whereby the recess tapers off towards its bottom.

45. The gripping system according to claim 42 wherein the centering extremity of the centering arrangement can be shifted in relation to a center opening of an individual item to compensate for differential thicknesses of individual items.

46. The gripping system of claim 42 further comprising a plurality of grips that rotate in cycles about a common drive axis, in order to transport individual items from one place of deposit to another, whereby in particular at least one of the deposit places is moved; a plurality of feed arms arranged about the axis of rotation whereby on one feed arm there is hinged at least a single-arm bearing at least one grip, whereby the location of the carrier arm in relation to the feed arm can be controlled during rotation.

47. The gripping system of claim 46 wherein the hinged arm is a twin carrier arm.

48. The gripping system of claim 46 wherein the feed arms are arranged on one plane perpendicular to the axis of rotation.

49. The gripping system according to claim 46 wherein there is secured onto the carrier arm a first cogwheel, in which a twin-arm lever revolving on at least one feed arm about an axis mates with a second cogwheel displaying teeth on one arm, whereby the second cogwheel is moved by a deflection of the second lever arm, abutting with its end at a control cam.

50. The gripping system of claim 49 wherein the control cam is a cam plate.

51. A transport carrier comprising a carrier body having for engagement a recess into a centering end of a centering arrangement of a grip, wherein the recess is arranged on a portion of the carrier body which can be displaced perpendicular to a deposit surface.

52. The transport carrier of claim 51 wherein the deposit surface is spring-mounted in the carrier body.

53. A method for imprinting individual items, such as CDs or DVDs, comprising: utilizing at least one printing station, one or more printing processes, transporting individual items to the at least one printing station on a transport path in transport carriers, placing the individual items in transport carriers; and the picking up individual items from the transport carriers by means of grips wherein the picking up takes place during a motion of the grips and the transport carriers, and wherein the centering of the individual items in relation to a transport carrier takes place during the process of delivery.

54. The method of claim 53 wherein the individual items are disk media such as CDs or DVDs.
